(19) United States
(12) Patent Application Publication
(10) Pub. No.: US 2002/0167175 A1
(43) Pub. Date: Nov. 14, 2002

(54) Motor vehicle gate lock arrangement

(75) Inventors: Bernd Weyerstall, Wuppertal (DE); Michael Gampe, Velbert (DE)

Correspondence Address: NIXON PEABODY, LLP, 8180 GREENSBORO DRIVE, SUITE 800, MCLEAN, VA, 22102, US

(73) Assignee: Robert Bosch GmbH, Stuttgart (DE)

(21) Appl. No.: 10/132,716

(22) Filed: Apr. 26, 2002

Related U.S. Application Data
(63) Continuation-in-part of application No. 10/058,239, filed on Jan. 29, 2002, now abandoned.

(30) Foreign Application Priority Data
Jan. 30, 2001 (DE) 101 04 300.7
Nov. 30, 2001 (DE) 101 58 733.3

(51) Int. Cl. E05C 3/06

(52) U.S. Cl. 292/196

(57) ABSTRACT

A lock for a motor vehicle gate or door including a lock latch having a main catch projection which is movable between an open position that disengages the gate or door lock and a catch position that engages the gate or door lock, a detent pawl which is movable between a lowered position maintaining the lock latch in the catch position and a raised position to place the lock latch in the open position, a catch lever which is being movable from a first position maintaining the detent pawl in the catch position and a second position placing the detent pawl in the open position, and a handle connected to the catch lever at a location in an interior area of the gate or door. The handle is movable to an actuating position which places the catch lever in the second position to thereby disengage the gate or door lock from the inside area of the gate or door.

### CROSS-REFERENCE TO RELATED APPLICATION

This application is a continuation-in-part of co-pending U.S. patent application Ser. No. 10/058,239.

### BACKGROUND OF THE INVENTION

1. Field of the Invention

The invention relates to a motor vehicle gate lock arrangement, such as a lock arrangement for a trunk lid. The invention also relates to a motor vehicle rear door lock arrangement.

2. Field of the Related Art

Motor vehicle gate lock arrangements and motor vehicle rear door lock arrangements of the type under consideration are known both with manual activation and also with motorized activation (motorized opening aid). Gate locks are known generally with a catch, the main catch, rear door locks and side door locks with two catches, specifically the main catch and a preceding preliminary catch which secures the preliminary catch position of the door. Published German Patent Application DE 196 14 122 A1 and corresponding U.S. Pat. No. 5,934,717, describe this prior art comprehensively for locks with a lock latch and detent pawl, said U.S. Pat. No. 5,934,717 being incorporated herein by reference.

For locks without a lock latch, in which the detent pawl acts directly on a closing clip or the like, reference is made to published German Patent Application DE 19 64 260 A1. This known lock has a key collar with a preliminary catch and a main catch in which a detent pawl engages.

In motor vehicle gate lock arrangements and also in motor vehicle rear door lock arrangements of the type under consideration, a so-called “snow load lever” is used. It is also comprehensively described in published German Patent Application DE 196 14 122 A1. A snow load lever is an additional catch lever which engages when the raised position of the catch blade is reached relative to the detent pawl, such that the detent pawl is kept in the raised position until the lock latch, generally a rotary latch, has reached its open position. When the lock latch has reached its open position, the additional catch lever is pivoted away from the detent pawl so that it can operate again relative to the rotary latch. When the gate or rear door is closed again, the catch lever engages again in the main catch or first in the preliminary catch and then in the main catch.

The aforementioned mechanical technique is proven and effective since it solves a problem of a gate or door which does not open by itself, either when loaded with snow, when the restoration force of the seal is not sufficient, or when the seal is frozen tight.

The function of a “snow load lever” has already been addressed in a gate lock or rear door lock which can be opened by motor, specifically by a corresponding stop control. This is the subject matter of the teaching of published German Patent Application DE 196 14 122 A1.

Although development in motor vehicle gate lock arrangements, as in motor vehicle rear door lock arrangements, has already reached a considerable status with respect to implementation of a “snow load function,” as before, further development is necessary.

### SUMMARY OF THE INVENTION

In accordance with the invention, further development is undertaken such that the gate lock of the gate lock arrangement, especially the rear lid lock of a motor vehicle body, can also be opened from the inside, and thus, from the inside of the gate, by way of an inside opening handle. Accordingly, an individual, such as a child, who has been inadvertently locked in or has become trapped when playing in the trunk of a motor vehicle can always escape from the trunk by himself. But in accordance with the invention, the catch lever, which implements the “snow load function” from the outside during opening, is used to keep the detent pawl likewise in the lifted position upon actuation from the inside opening handle. In this way, a safety measure is taken in that pulling from the inside of the gate one time on the inside opening handle is enough in any case to be able to press the gate up, especially the trunk lid. Thus, even when an individual reacts by panicking when trapped, reliable opening of the gate is possible and escape is ensured.

An advantageous feature in accordance with the invention is that the catch lever is activated by actuating the inside opening handle, and is coupled to the inside opening handle such that the catch lever can be deactivated again only by an additional actuation measure with release of a detent pawl. Because an additional actuation measure leads to deactivation of the catch lever and re-release of the detent pawl, a further improvement in ease of operation is achieved. If specifically the gate, such as the trunk lid, is closed by the pressure of a load or wind gust without the loading or unloading process not yet being completed, in this design the gate lock does not engage if it has been moved beforehand into the desired catch position by actuating the inside opening handle. By way of this additional manipulation on the inside opening handle which is present anyway, an additional luxury function is implemented because tedious looking for the key or the remote control can be reliably abandoned. Deactivation of the catch lever can take place by a manual actuation measure in the same way as by a motorized actuation measure when the gate lock is motorized.

A corresponding function can be implemented in a motor vehicle rear door lock arrangement whereby the catch lever, which is activated by actuating the inside opening handle, is coupled to the inside opening handle such that the catch lever can be deactivated again only by an additional actuation measure with release of the detent pawl.

A corresponding function can also be implemented when there is no inside opening handle on the gate or rear door. Then, in accordance with the invention, an additional catch-actuation element which assumes the function of the inside opening handle with respect to the additional catch lever.

The implementation of the teaching in accordance with the invention is made especially compact and user-friendly in that the inside opening handle or the catch-actuation element is made as a rotating or rotary actuating handle. With this rotary actuating handle, which has an engagement element and a mechanical interface, the detent pawl can be shifted into its raised position. In a quite special embodiment, the aforementioned catch lever can be integrated in terms of its function into the rotary actuating handle.

The teaching of the invention can be applied to almost all known motor vehicle gate locks, especially locks with a lock latch and detent pawl as well as locks without a lock latch in which the detent pawl acts directly on the closing clip or the like should be considered.

The invention is explained in detail below with reference to the accompanying drawings which show only some of the various possible embodiments of the invention.

### BRIEF DESCRIPTION OF THE DRAWINGS

FIG. 1 is a side view of the rear of a motor vehicle body with a partially opened trunk lid and a gate lock arrangement for the trunk lid;

FIG. 1A is an enlarged view of the encircled detail “A” of FIG. 1;

FIGS. 2A & 2B show an inside opening handle or a catch-actuation element in accordance with the invention in perspective and side views, respectively;

FIGS. 3A & 3B show another inside opening handle or catch-actuation element according to the invention in perspective and side views, respectively;

FIG. 4 shows an arrangement of the detent pawl and inside opening handle or a catch-actuation element in accordance with the invention; and

FIG. 5 shows another view of the arrangement of the detent pawl and inside opening handle or a catch-actuation element shown in FIG. 4.

### DETAILED DESCRIPTION OF THE INVENTION

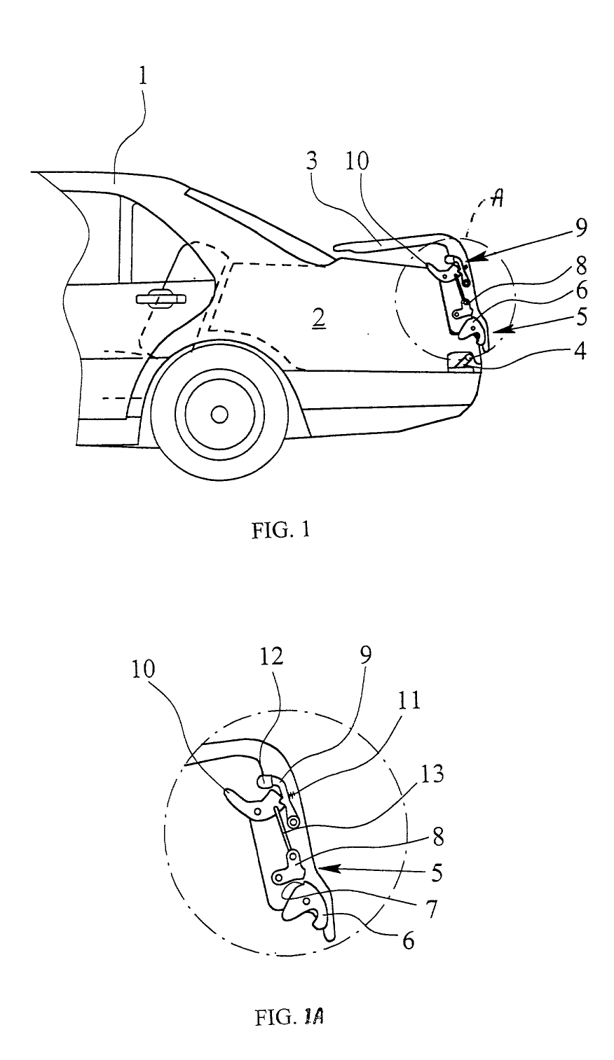

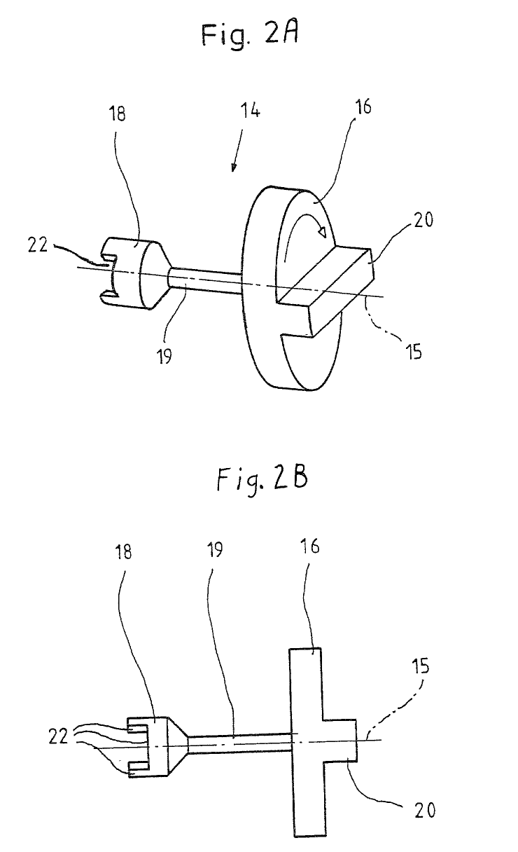

FIGS. 1 & 1A show the rear of a motor vehicle body 1 with the trunk space 2 which is closed by a trunk lid 3 or trunk gate. The trunk lid 3 is easily raised to expose an interior space of the trunk. The frame of the trunk includes a closing clip 4. As more clearly shown in FIG. 2, on the trunk lid 3, itself, is the gate lock arrangement including a gate lock 5 with a lock latch 6, a main catch 7 and a detent pawl 8 which keeps the latch lock 6 in the main catch position.

FIGS. 1 & 1A illustrate only a highly schematic representation of a first embodiment and are intended to explain the basic principle of the invention. All other parts of such a gate lock arrangement are omitted from these figures. For example, an outside opener and a central interlock mechanism, as well as a motorized opening drive, auxiliary closing drive or central interlock drive are omitted. In this respect, reference is made to the prior art, especially to the initially mentioned U.S. Pat. No. 5,934,717, but such structure can also be found in German Patents DE 38 01 581 C2 and DE 39 32 268 C2, as well as published German Patent Application DE 32 42 527 A1.

In the above-explained gate lock 5 of FIGS. 1 & 1A, a “snow load function” is implemented. For this purpose, after reaching the raised position, the detent pawl 8 is kept in the raised position by way of a catch lever 9 proceeding from the main catch position until the lock latch 6 has reached its open position shown in the drawings.

Normally, the gate of a trunk 2, in this case the trunk lid 3, can only be opened from the outside. There is no inside opening mechanism because cargo is carried in the trunk2. This is different than in the cargo space of a station wagon which is closed with a rear door. In such a vehicle, a rearward facing, third bench seat can often be installed so that the rear door is already equipped beforehand with an inside opening handle.

FIGS. 1 & 1A show a feature whereby an inside opening handle 10 is provided on the inside of the gate 3; by its activation with the hatch 3 closed, the detent pawl 8 can be moved into the raised position and can be held there until the lock latch 6 has reached its open position. Thus, the additional function of a panic safety which is described in the general part of the specification is achieved, the gate 3 can then always be completely opened by the individual inside.

According to one preferred embodiment, it is furthermore provided that the catch lever 9 is coupled to the inside opening handle 10 so that the catch lever 9 may be activated by actuating the opening handle 10. In addition, the catch lever 9 is coupled to the inside opening handle 10 such that the catch lever 9 can be deactivated again by an additional actuation measure with release of the detent pawl 8. FIGS. 1 & 1A indicate that the catch lever 9 is located directly on the inside opening handle 10, and under the force of a spring 11, engages when the inside opening handle 10 is activated and keeps the inside opening handle 10 in the actuation position.

The drawings show that the catch lever 9 has an actuation end 12 and by pressing on the actuation end 12 against the reset force of the spring 11 can be pressed back, and thus, deactivated so that the detent pawl 8 can engage again because the inside opening handle 10 has been released again. As an alternative, a latch can also be provided which rises under spring force and which fixes the inside opening handle 10 in the actuation position as soon as the inside opening handle 10 has been pulled. Of course, the catch lever 9 can be assigned directly to the detent pawl 8 in the known manner, and, for this reason, can be located directly on the gate lock 5 itself. The manner of operation of the catch lever 9 within the framework of the teaching of the invention is always important; this leads to the fact that the gate 3 cannot engage and lock unintentionally with the catch function activated.

In the embodiment shown in the FIGS. 1 & 1A, the inside opening handle 10 is in the top area of the gate 3, and the gate lock 5 in the lower area by the edge of the gate 3. A transfer rod 13 couples the detent pawl 8 to the inside opening handle 10 in this respect. One alternative is to support the inside opening handle 10 directly on the pivot axis of the detent pawl 8, therefore, to provide direct actuation of the detent pawl 8. The inside opening handle 10 can also be located elsewhere on the hatch lock 5.

In addition, a reversed arrangement of the closing clip 4 and the hatch lock 5 in an assignment to the trunk lid 3 and the frame of the trunk 2 is known and can be realized. This embodiment is a special version in which the catch lever 9 is activated only when the inside opening handle 10 is actuated. When the gate lock 5 is actuated from the outside via the external actuation lever or via a remote control, therefore by a motor, the additional catch function is not activated by the catch lever 9. It is, therefore, only activated as an emergency function by an individual locked in the trunk 2 or is intentionally activated with the hatch 3 opened.

In engineering and structural terms, the above-explained concept can be implemented while maintaining the “snow load function” in that, optionally, there is an additional catch lever with the same function, which is activated in some other fashion such as from the outside or via a remote control and is deactivated by the lock latch 6 when the open position of the lock latch 6 is reached. Thus the, “classical” snow load function in addition to the above-explained modified snow load function is present. The above-explained concept can be implemented otherwise in a motor vehicle rear door lock arrangement with the same advantage.

Finally, the above explained concept can also be implemented when there is no inside opening handle 10. In such a case, on the inside of the gate 3 or the rear door, there must be another catch-actuation element which may be activated and deactivated. Finally, it is fundamentally conceivable for the catch-actuating element to be activated and deactivated by motor, for example, within the framework of more complex remote control.

In addition, it can be provided that by pulling on the inside opening handle 10 via a power transmission cable, especially a Bowden cable, on the hinge of the gate 3 a catch is activated which allows only one opening motion of the gate 3, but no longer allows a closing motion. This catch can likewise be deactivated again by active manipulation of the catch lever 9 or a catch-actuation element. After deactivation of this catch normal opening and closing of the gate 3 from the outside is possible again.

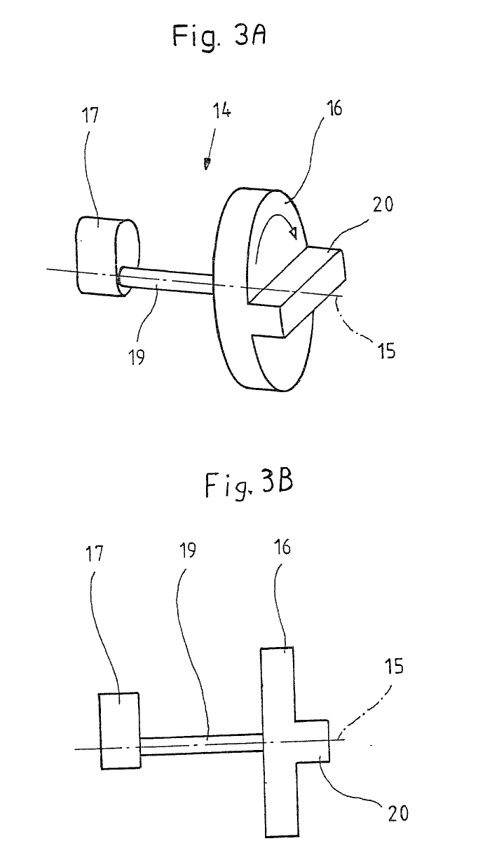

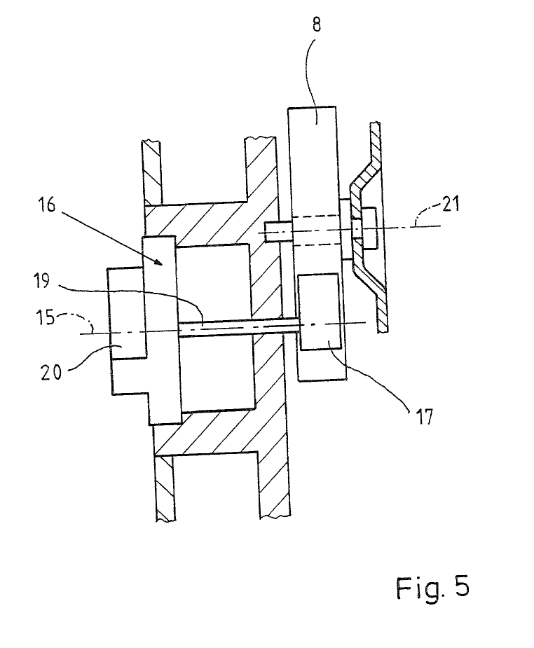

In the implementation of the teaching of the invention, especially with one of the aforementioned embodiments, it is especially advantageous if the inside opening handle 10 or the catch-actuation element is made as a rotary actuating handle 14. This is shown schematically in FIGS. 2-5. The rotary actuating handle 14 can be turned about the axis of rotation 15.

The rotary actuating handle 14 has an engagement element 16 and a mechanical interface 17, 18 which are rigidly coupled to one another, here, by a shaft 19. The engagement element 16 is made such that it can be easily operated by hand. It is preferably made as a turning knob which has an engagement bar 20 which runs transversely relative to the axis of rotation 15 through the axis of rotation 15. When the rotary actuating handle 14 is actuated, the mechanical interface 17, 18 acts directly or indirectly on the detent pawl 8 such that the latter is shifted into its raised position.

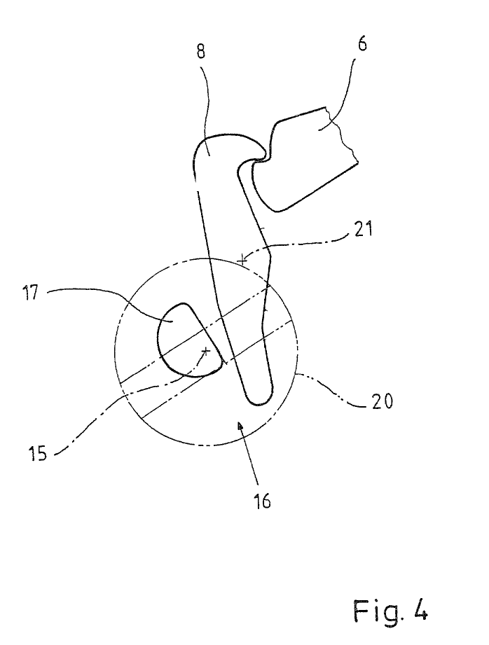

In one especially preferred embodiment of the invention (FIG. 4), the mechanical interface 17 is made as a cam or cam disk and acts directly on the detent pawl 8. In doing so, when the rotary actuating handle is actuated, the cam or cam disk 17 presses against the detent pawl 8 such that it is displaced around a pivot axis 21 into its raised position.

One preferred embodiment of the cam or the cam disk 17 leads to the fact that, when the rotary actuating handle 14 has been actuated, therefore when the cam or cam disk 17 has moved the detent pawl 8 into its raised position, a state of stable equilibrium is produced. Then, the rotary actuating handle 14 remains in the actuated position and the detent pawl 8 in its raised position until it is turned manually back into its initial position. Therefore, here, another actuating measure is also necessary to release the detent pawl 8. Thus, the rotary actuating handle 14, at the same time, assumes the function of the catch lever 9, the catch lever 9 being integrated in terms of its function into the rotary actuating handle 14.

According to another preferred embodiment (FIGS. 2A, 2B), the mechanical interface 18 is made such that it has shaped parts 22 which fit into corresponding opposing shaped parts of the detent pawl 8 when the rotary actuating handle 14 is actuated, and thus, enable displacement of the detent pawl 8 into its raised position. As a result, the shaped parts 22, with the opposing shaped parts, form an interlocking coupling connection; they are known from the prior art in diverse forms. The implementation is made especially simple when the mechanical interface 18 in the rotary axis 21 engages the detent pawl 8 and the axis of rotation 15 of the rotary actuating handle 14 coincides with the axis 21 of rotation of the detent pawl 6.

To prevent malfunction, it is furthermore a good idea to make the rotary actuating handle 14 such that effective actuation, i.e., displacement of the detent pawl 8, is only possible when the rotary actuating handle 14 is turned on the engagement element 16 or on the bar 20, and at the same time, is pressed in the direction of the axis of rotation 15. With the aforementioned interlocked coupling, such an implementation is easily possible. The interlocking would only occur in this implementation if the rotary actuating handle 14 were pressed in. Thus, unwanted raising of the detent pawl can be easily avoided.

What is claimed is:

1. Motor vehicle gate lock comprising:
a lock latch having a main catch projection, said lock latch being movable between a catch position engaging the lock and an open position disengaging the lock;
a detent pawl for engaging said main catch projection when said lock latch is in said catch position, said detent pawl being movable between a lowered position maintaining said lock latch in said catch position and a raised position permitting movement of said lock latch to said open position;
a catch lever, said catch lever being movable from a first position maintaining said detent pawl in the catch position and a second position placing said detent pawl in said open position; and
an interior handle for disengaging the gate lock, said handle being connected to said detent pawl such that when the gate of the motor vehicle is closed, activation of said interior handle causes movement of said detent pawl to said raised position.

2. Motor vehicle gate lock arrangement, comprising:
a closing clip,
a lock latch,
a catch lever, and
a detent pawl, and
an inside opening handle on an inner side of a vehicle gate;
wherein the detent pawl and the closing clip are jointly movable into at least a main catch position; wherein the detent pawl is directly engageable with the closing clip for keeping the closing clip in the main catch position; and wherein the catch lever is operable to keep the detent pawl in a raised position from the main catch position until the closing clip leaves the main catch position, wherein, with the gate closed, the inside opening handle is movable into a raised position in a manner moving the detent pawl into its raised position and holding the detent pawl there until the closing clip leaves the main catch position.

3. Motor vehicle gate lock as claimed in claim 1, wherein said interior handle is connected to said catch lever to move said catch lever from said first position to said second position when the motor vehicle gate is closed, said catch lever being movable from said second position to first second position by release of said detent pawl when the motor vehicle gate is open.

4. Motor vehicle gate lock as claimed in claim 1, further comprising a second catch lever that is actuated separately with respect to said catch lever, said second catch lever being movable between a position maintaining said detent pawl in said catch position and a position placing said detent pawl in said open position.

5. Motor vehicle gate lock arrangement, comprising:
a closing clip,
a catch lever, and
a rear door lock with a detent pawl, and
an inside opening handle on an inner side of a rear door;
wherein the detent pawl and the closing clip are jointly movable into at least a main catch position; wherein the detent pawl is directly engageable with the closing clip for keeping the closing clip in the main catch position; and wherein the catch lever is operable to keep the detent pawl in a raised position, from the main catch position until the closing clip leaves the main catch position, wherein, with the rear door closed, the inside opening handle is movable into a raised position in a manner moving the detent pawl into its raised position; and wherein the catch lever is coupled to the inside opening handle in a manner causing the catch lever to be activated by a first actuation of the inside opening handle and deactivated again by an additional actuation of the inside opening handle to release the detent pawl

6. Motor vehicle gate lock as claimed in claim 1, further comprising a spring connected to said catch lever, said connection between said catch lever and said handle being such that said spring acts in a direction for maintaining said handle in said actuating position.

7. Motor vehicle lock arrangement as claimed in claim 1, wherein the detent pawl is adapted to be activated only when the inside opening handle is actuated.

8. Motor vehicle gate lock as claimed in claim 1, wherein said catch lever is manually movable from said second position to said first position when the gate lock is disengaged.

9. Motor vehicle gate lock as claimed in claim 1, wherein said catch lever is mechanically movable from said second position to said first position when the gate lock is disengaged.

10. Motor vehicle gate lock as claimed in claim 1, further comprising a clip mechanism for attachment to the motor vehicle gate, said clip mechanism forming a releasable lock interconnection with said detent pawl when the motor vehicle gate is closed.

11. Motor vehicle gate lock as claimed in claim 1, further comprising a second catch movable between a position preventing engagement of the lock once the motor vehicle gate is open and a position permitting engagement of the lock once the motor vehicle gate is closed.

12. Motor vehicle door lock comprising:
a lock catch having a main catch projection, said lock catch being movable between a catch position engaging the lock and an open position disengaging the lock;
a detent pawl for engaging said main catch projection when said lock latch is in said catch position, said detent pawl being movable between a lowered position maintaining said lock latch in said catch position and a raised position permitting movement of said lock latch to said open position;
a catch lever, said catch lever being movable from a first position maintaining said detent pawl in the catch position and a second position placing said detent pawl in said open position; and
an interior handle for disengaging said gate lock,
wherein said interior handle is connected to said catch lever to move said catch lever from said first position to said second position when the motor vehicle door is closed, said catch lever being movable from said second position to said first position by release of said detent pawl when the motor vehicle door is open.

13. Motor vehicle lock arrangement comprising:
a closing clip;
a catch lever;
a lock latch with a detent pawl; and
an inside opening handle on an inner side of one of a vehicle door and vehicle gate;
wherein the detent pawl and the closing clip are jointly movable into at least a main catch position; wherein the detent pawl is directly engageable with the closing clip for keeping the closing clip in the main catch position; and wherein the catch lever is operable to keep the detent pawl in a raised position from the main catch position until the closing clip leaves the main catch position; wherein the detent pawl and the closing clip jointly movable into the main catch position, the detent pawl directly engaging the closing clip and keeping the closing clip in the main catch position, and after reaching the raised position, wherein the catch lever is adapted to hold the detent pawl the raised position, proceeding from the main catch position, until the closing clip leaves the main catch position, wherein, a catch-actuation element is provided on the inner side of said one of a vehicle door and vehicle gate, said catch-actuation element, with said one of a vehicle door and vehicle gate opened, being actuatable by at least one of a manual operation from an outer side of said one of a vehicle door and vehicle gate and a motor, and wherein the catch lever is activatable and blockable by repeated operation of the catch-actuation element.

14. Motor vehicle door lock as claimed in claim 12, further comprising a second catch lever that is actuated separately with respect to said catch lever, said second catch lever being movable between a position maintaining said detent pawl in the catch position and a position placing said detent pawl in said open position.

15. Motor vehicle door lock as claimed in claim 12, further comprising a spring connected to said catch lever, said connection between said catch lever and said handle being such that said spring is acts in a direction for maintaining said handle in said actuating position.

16. Motor vehicle door lock as claimed in claim 12, wherein said catch lever is manually movable from said second position to said first position when the door lock is disengaged.

17. Motor vehicle door lock as claimed in claim 12, wherein said catch lever is mechanically movable from said second position to said first position when the door lock is disengaged.

18. Motor vehicle door lock as claimed in claim 12, further comprising a clip mechanism for attachment to the motor vehicle door, said clip mechanism forming a releasable lock interconnection with said detent pawl when the motor vehicle door is closed.

19. Motor vehicle door lock as claimed in claim 12, further comprising a second catch movable between a position preventing engagement of the lock once the motor vehicle door is opened and a position permitting engagement of the lock once the motor vehicle door is closed.

20. A lock for locking at least one of a motor vehicle gate and a motor vehicle door, the lock comprising:
a lock latch having a main catch projection, said main catch being movable between a catch position engaging the lock and an open position disengaging the lock;
a detent pawl for engaging said main catch projection when said lock latch is in said catch position, said detent pawl being movable between a lowered position maintaining said lock latch in said catch position and a raised position permitting movement of said lock latch to said open position;
a catch lever, said catch lever being movable from a first position maintaining said detent pawl in the catch position and a second position placing said detent pawl in said open position; and
an actuation mechanism for disengaging the lock,
wherein said actuation mechanism is connected to said catch lever to move said catch lever from said first position to said second position when said at least one of the motor vehicle gate and the motor vehicle door is closed, said catch lever being movable from said second position to said first position by release of said detent pawl when said at least one of the motor vehicle gate and the motor vehicle door is open.

21. Lock as claimed in claim 20, further comprising a second catch lever that is actuated separately with respect to said catch lever, said second catch lever being movable between a position maintaining said detent pawl in the catch position and a position placing said detent pawl in said open position.

22. Motor vehicle lock arrangement as in claim 13, wherein one of the inside opening handle and the catch-actuation element is adapted, upon activation thereof, to prevents closing of an opened gate or the rear door on which it is mounted until deactivation thereof by an additional actuation of said one of the inside opening handle and the catch-actuation element.

23. Motor vehicle lock arrangement as claimed in claim 13, wherein one of the inside opening handle and the catch-actuation element is a rotary actuating handle, and wherein the rotary actuating handle is rotatable around an axis of rotation.

24. Motor vehicle lock arrangement as claimed in claim 23, wherein the rotary actuating handle has an engagement element and a mechanical interface, wherein the engagement element and the mechanical interface are rigidly coupled to one another, and wherein the mechanical interface is adapt to act on the detent pawl so as to move the detent pawl into its raised position when the rotary actuating handle is actuated.

25. Motor vehicle lock arrangement as claimed in claim 24, wherein the mechanical interface of the rotary actuating handle has one of the cam and cam disk, and wherein said one of the cam and cam disk is adapted to act directly on the detent pawl so as to move the detent pawl into its raised position when the rotary actuating handle is actuated.

26. Motor vehicle lock arrangement as claimed in claim 25, wherein said one of the cam and cam disk of the mechanical interface of the rotary actuating handle is adapted to be in a state of stable equilibrium when the detent pawl in its raised position, and wherein the catch lever is functionally integrated into the rotary actuating handle.

27. Motor vehicle lock arrangement as claimed in claim 24, wherein the mechanical interface of the rotary actuating handle has shaped parts, wherein the detent pawl has corresponding opposing shaped parts, and wherein the shaped parts and the opposing shaped parts are adapted fit into one another for enabling the detent pawl to be moved into its raised position when the rotary actuating handle is actuated.
